(19) United States
(12) Patent Application Publication
(10) Pub. No.: US 2025/0122969 A1
(43) Pub. Date: Apr. 17, 2025

(54) TEST PLUG FOR SPRINKLER ADAPTER

(71) Applicant: IPEX USA LLC, Pineville, NC (US)

(72) Inventors: Jeyapandian G, Madurai (IN); Robert Alan Hackett, Cranston, RI (US); Joshua P. Davis, Ashaway, RI (US); Ray W. Decker, Allentown, PA (US); Thomas Hamilton Gaines, Medina, OH (US); Nicholas Rosa, Westport, MA (US); John Lawrence Charles Seligman, Alhambra, CA (US); Sean E. Cutting, Wood River Junction, RI (US)

(21) Appl. No.: 18/912,145

(22) Filed: Oct. 10, 2024

(30) Foreign Application Priority Data
Oct. 13, 2023 (IN) 202341069074
Dec. 19, 2023 (IN) 202341086722

(51) Int. Cl. F16L 55/11; F16L 55/10

(52) U.S. Cl. CPC F16L 55/1108; F16L 55/1026

(57) ABSTRACT

A test plug for use with a sprinkler adapter or a fluid supply piping outlet is provided. The test plug includes a winged head to operate the test plug and a post member that protrudes from the winged head and engages with the sprinkler adapter or the fluid supply piping outlet.

### FIELD OF INVENTION

The present disclosure relates generally to fire suppression systems. More particularly, the present disclosure relates to a test plug for sprinkler adapters.

### BACKGROUND

As per National Fire Protection Association (NFPA) rules and guidelines, water-based fire suppression system requires frequent inspection, testing, and maintenance to guarantee that system's health is up to the mark. Hydraulic testing is one such activity performed prior to commissioning of the fire suppression system to ensure health of the system. During hydraulic testing, instead of a sprinkler, a test plug is attached to each sprinkler adapter outlet and pressurized water is introduced into the system. The system is then checked for leaks, proper pressure, and proper flow rates to ensure that the design specification and safety standards are met. There is therefore, felt a need to provide a test plug that is easy to install and does not damage sprinkler adapter during hydraulic testing.

### SUMMARY

One implementation of the present disclosure relates to a test plug for use with a sprinkler adapter or a fluid supply piping outlet. The test plug includes a winged head to operate the test plug and a post member protruding from the winged head and configured to engage or engages with the sprinkler adapter or the fluid supply piping outlet.

In some embodiments, the winged head includes a central portion having a base, a top, and a curved surface extending between the base and the top.

In some embodiments, the central portion has conical shape that tapers from the base to the top.

In some embodiments, the post member is provided at the base of the central portion.

In some embodiments, the winged head further includes one or more wings.

In some embodiments, the one or more wings are flat surfaces that enable a secure grip during installation or removal of the test plug.

In some embodiments, the one or more wings are orthogonal to the post member.

In some embodiments, each wing has a first edge proximal to the top of the central portion and a second edge proximal to the base of the central portion. In some embodiments, the first edge is longer than the second edge.

In some embodiments, the test plug further includes a conical section provided at the top of the winged head. In some embodiments, the conical section terminates in a marking point.

In some embodiments, the marking point of the conical section functions as an alignment feature for installation of one or more interior finish elements.

In some embodiments, the post member further includes a first portion engageable with the sprinkler adapter or the fluid supply piping outlet and a second portion such that the second portion is provided between the winged head and the first portion.

In some embodiments, the test plug further includes a spacer provided between the first portion and the second portion.

In some embodiments, the first portion is provided adjacent to the second portion.

In some embodiments, the first portion has undercut threads formed thereon for engagement with the sprinkler adapter or the fluid supply piping outlet.

In some embodiments, a length of a portion of the test plug that remains outside the sprinkler adapter or the fluid supply piping outlet after the first portion is engaged with the sprinkler adapter or the fluid supply piping outlet is greater than or equal to ⅝ inches.

In some embodiments, a length of a portion of the test plug that remains outside the sprinkler adapter or the fluid supply piping outlet after the first portion is engaged with the sprinkler adapter or the fluid supply piping is less than or equal to 4 inches.

In some embodiments, the first portion incorporates a hollow space therein.

In some embodiments, the test plug further comprises a flanged portion provided at a junction of the first portion and the second portion. In some embodiments, the flanged portion extends outwards in a radial direction from the post member. In some embodiments, a length defined between the flanged portion and the top is greater than or equal to ⅝ inches. In some embodiments, a length defined between the flanged portion and the top is less than or equal to 4 inches.

In some embodiments, the flanged portion comprises a first surface and an opposing second surface such that the first surface faces the first portion and the second surface faces the second portion.

In some embodiments, the test plug engages with a seal member of the sprinkler adapter or the fluid supply piping outlet to form a fluid tight seal.

In some embodiments, the test plug is a one piece construction.

Another implementation of the present disclosure relates to a test plug for a sprinkler adapter or the fluid supply piping outlet. The test plug includes an elongate body having one or more wings protruding therefrom and a portion that is configured to engage or engages with the sprinkler adapter. The one or more wings are operable to engage the test plug with the sprinkler adapter or the fluid supply piping outlet.

Yet another implementation of the present disclosure relates to a fire suppression system. The fire suppression system includes a sprinkler adapter, a sprinkler assembly, and a test plug. The sprinkler adapter is engageable (i) with the sprinkler assembly during non-hydraulic testing period of the fire suppression system and (ii) with the test plug during hydraulic testing period of the fire suppression system. The test plug includes a winged head operable to engage the test plug with the sprinkler adapter, and a post member protruding from the winged head and configured to engage with the sprinkler adapter.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a diagram that illustrates a fire suppression system, according to some embodiments of the present disclosure.

FIG. 2 is a diagram that illustrates a sprinkler adapter engageable with a test plug or a sprinkler assembly, according to some embodiments of the present disclosure.

FIG. 3 is a diagram that illustrates the test plug of FIG. 2 to be used during hydraulic testing of fire suppression system, according to some embodiments of the present disclosure.

FIG. 4 is a diagram that illustrates a test plug of to be used during hydraulic testing of fire suppression system, according to some other embodiments of the present disclosure.

FIG. 5 is a diagram that illustrates a test plug of to be used during hydraulic testing of fire suppression system, according to some other embodiments of the present disclosure.

FIG. 6 is a diagram that illustrates a fitting engaged with the test plug of FIG. 5, according to some embodiments of the present disclosure.

FIGS. 7A-7C are diagrams that illustrate a test plug to be used during hydraulic testing of fire suppression system, according to some other embodiments of the present disclosure.

FIG. 8 is a diagram that illustrates a fitting engaged with the test plug of FIG. 7A, according to some embodiments of the present disclosure.

### DETAILED DESCRIPTION

### Overview

The following presents a simplified overview of one or more aspects in order to provide a basic understanding of such aspects. This overview is not an extensive overview of all contemplated aspects, and is intended to neither identify key or critical elements of all aspects nor delineate the scope of any or all aspects. The sole of purpose of this overview is to present some concepts of one or more aspects in a simplified form as a prelude to the mode detailed description that is presented later. Referring generally to the FIGURES, an arrangement for performing a drain test on a fire suppression system is shown, according to an exemplary embodiments.

Water-based fire suppression systems require frequent inspection, testing, and maintenance to guarantee that system's health is up to the mark. Hydraulic testing is one such activity performed prior to commissioning of a fire suppression system to ensure health of the system. During hydraulic testing, instead of a sprinkler, a test plug is attached to each sprinkler adapter outlet and pressurized water is introduced into the system. The system is then checked for leaks, proper pressure, and proper flow rates to ensure that the design specification and safety standards are met. The present disclosure provides a test plug that is easy to install at and remove from sprinkler adapter, and that does not damage the sprinkler adapter during installation and removal.

The test plug includes an elongate body having one or more wings protruding therefrom and a portion that can be engaged with the sprinkler adapter. The one or more wings are easily operable to install or remove the test plug from the sprinkler adapter. The test plug is provided as one piece construction. Structural design of the test plug ensures ease of installation and removal by hand without the need of a tool, while also preserving the integrity of the sprinkler adapter.

Before turning to the Figures, it should be understood that the disclosure is not limited to the details or methodology set forth in the description or illustrated in the figures. It should also be understood that the terminology is for the purpose of description only and should not be regarded as limiting.

Referring generally to the Figures, an arrangement and a method for testing a fire suppression system is shown and described.

### Fire Suppression System

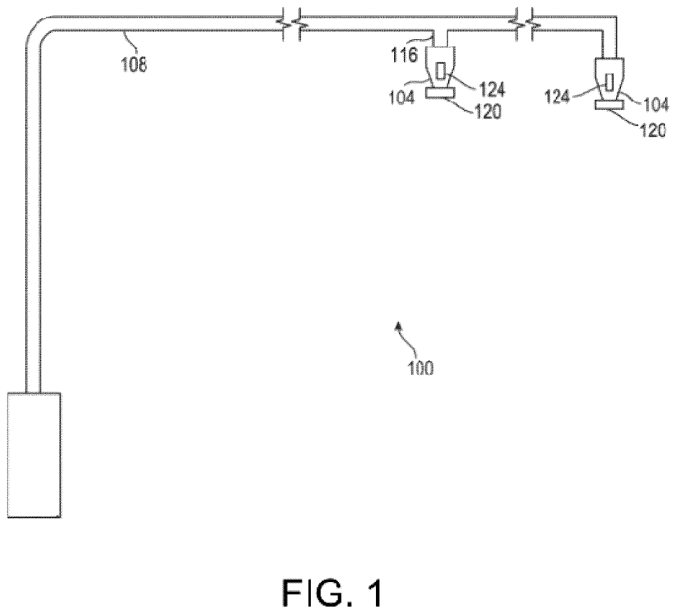

FIG. 1 is a diagram that illustrates a fire suppression system 100, according to some embodiments of the present disclosure. The fire suppression system 100 can distribute a fire suppressant agent onto or nearby a fire, extinguishing the fire and preventing the fire from spreading. The fire suppression system 100 can be used alone or in combination with other types of fire suppression systems (e.g., a building sprinkler system, a handheld fire extinguisher). Multiple fire suppression systems 100 can be used in combination with one another to cover a larger area (e.g., each in different rooms of a building). The fire suppression system 100 can be used in a variety of applications. The fire suppression system 100 can be used with a variety of fire suppressant agents, including but not limited to water (e.g., may use powders, liquids, foams, or other fluid or flowable materials). Further, the fire suppression system 100 can be a wet pipe system, a dry pipe system, a deluge system, a preaction system, an electronically activated fire suppression system, connected fire suppression systems, or the like.

The fire suppression system 100 can include or be coupled with a fluid supply 112. The fluid supply 112 can define an internal volume filled (e.g., partially filled, completely filled) with fire suppressant agent. The fluid supply 112 can provide fluid from a remote or local location to a building in which the fire suppression system 100 is located. The fluid supply may include, for example, a municipal water supply, pump, piping system, tank, cylinder, or any other source of water or fire suppression agent.

Piping 108 (e.g., one or more pipes, tubes, conduits, or fittings) can be fluidly coupled with one or more sprinklers 104. The piping 108 can include vertical pipes 116. The vertical pipes 116 can extend perpendicular from the piping 108. The sprinklers 104 can receive water or other fire suppressant agent from the fluid supply 112 via the piping 108 and the vertical pipes 116. Due to the reduced pressures that can be achieved through the sprinklers 104 while still achieving target outputs of fluid, at least some of the piping 108 can have connections or outlets with relatively lesser diameters, such as 1 inch NPT or IS0-7-R1 connections or outlets.

The sprinklers 104 can each define one or more outlets, through which the fire suppressant agent exits and contacts a deflector 120, such as to form a spray of water or other fire suppressant agent that covers a desired area. The sprays from the sprinklers 104 then suppress or extinguish fire within that area.

The deflectors 120 of the sprinklers 104 can be shaped to control the spray pattern of the fire suppressant agent leaving the sprinklers 104. The sprinklers 104 can be used as concealed sprinklers, pendent sprinklers, upright sprinklers, water mist nozzles, or any other device for spraying fire suppressant agent.

The sprinklers 104 can include an activation element (e.g., thermal element) 124. The activation element 124 can change from a first state that prevents fluid flow out of the sprinkler 104 to a second state that permits fluid flow of the sprinkler 104 responsive to a fire condition.

For example, the activation element 124 can include a glass bulb including a fluid that expands responsive to an increase in temperature (e.g., responsive to heat provided to the fluid from a fire), such as to cause the glass bulb to break responsive to the temperature meeting or exceeding a threshold temperature. In another example, the activation element 124 can include a fusible link that includes two or more pieces coupled using a solder than can melt responsive to the temperature meeting or exceeding a threshold temperature. In yet another example, the activation element 124 can include an electric actuator (e.g., an electrically triggered pyrotechnic actuator or electrically actuated bulb or link). The activation element 124 can have a response time index (RTI) less than or equal to 80 (m/s)^{1/2}, or less than or equal to 50 (m/s)^{1/2}. The activation element 124 can have a response time index (RTI) less than or equal to 120 (m/s)^{1/2} and greater than or equal to 15 (m/s)^{1/2}. The activation element 124 can have a temperature rating (e.g., nominal temperature at which the activation element changes from the first state to the second state) of 155 degrees Fahrenheit or greater.

The sprinklers 104 can be arranged (e.g., in a grid or tree arrangement over a storage commodity) to have sprinkler to sprinkler spacings greater than or equal to eight feet by eight feet, including but not limited to fourteen feet by fourteen feet.

### Test Plug for Sprinkler Adapter

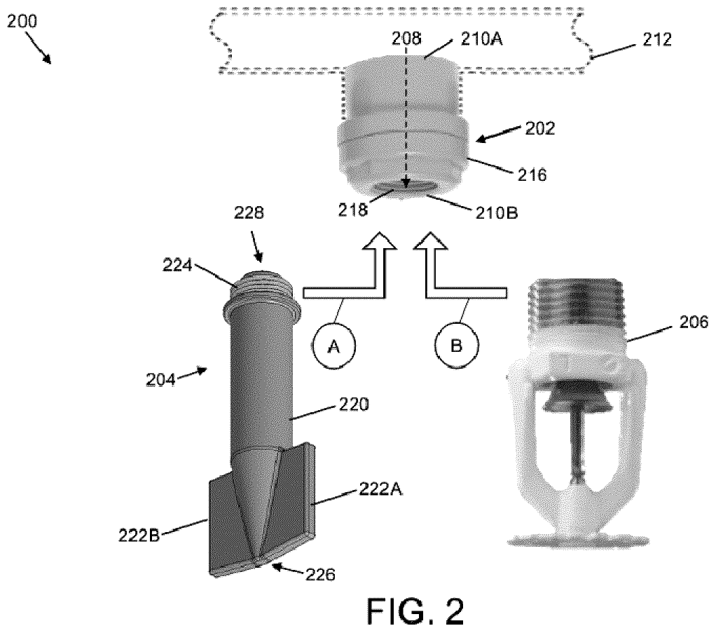

FIG. 2 is a diagram 200 that illustrates a sprinkler adapter 202 (e.g., a fitting) engageable with a test plug 204 or a sprinkler assembly 206, according to some embodiments of the present disclosure. The fire suppression system, e.g., the fire suppression system 100 of FIG. 1, may include the sprinkler adapter 202, the test plug 204, and the sprinkler assembly 206 along with other suitable components.

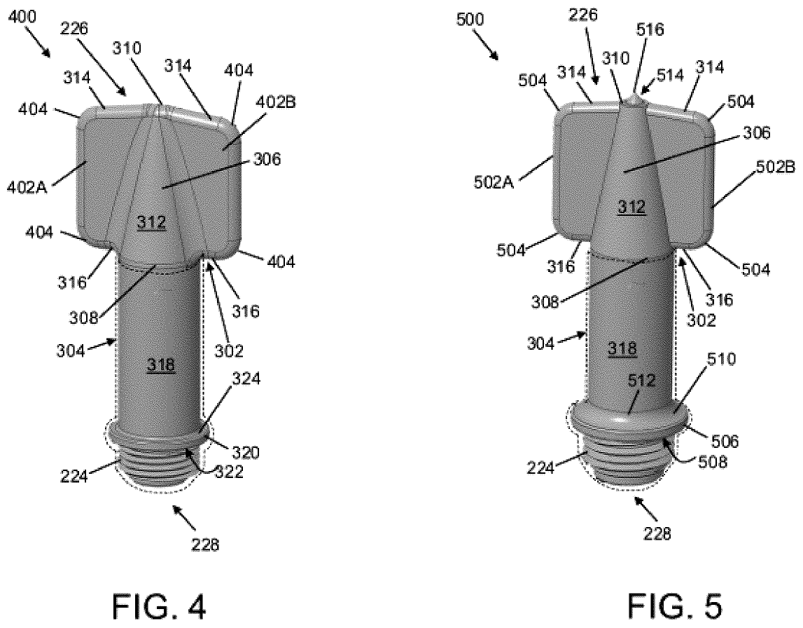

The sprinkler adapter 202 includes a housing 208 having an inlet end 210A for connection to fire-fighting fluid supply pipe fitting 212 and an outlet end 210B for connection to the test plug 204 or the sprinkler assembly 206 (e.g., any of the fire suppression devices 116 of FIG. 4). The inlet end 210A can be formed as either a female connector or a male connector for connecting the sprinkler adapter 202 to the fluid supply piping 212. The housing 208 is a substantially tubular member with an internal passageway 214 extending from the inlet end 210A to the outlet end 210B. Though the sprinkler adapter 202 is shown to be straight fitting, the scope of the disclosure is not limited to it. In some other embodiments, the sprinkler adapter 202 can be formed as a reducer fitting, an elbow fitting, or the like without deviating from the scope of the disclosure. The internal passageway 214 includes a receptacle 216 formed at the outlet end 210B with an internal thread 218 for a threaded engagement with the test plug 204 or the sprinkler assembly 206. In some embodiments, the sprinkler adapter 202 is a rapid seal adapter formed of, for example, Chlorinated Polyvinyl Chloride (CPVC) material.

As per National Fire Protection Association (NFPA) rules and guidelines, fire suppression systems (e.g., the fire system 100) require frequent inspection, testing, and maintenance to guarantee that system's health is up to the mark. Hydraulic testing is one such activity performed prior to commissioning of the fire suppression system to ensure system health, for example, identify leak spots or blockages in fluid supply piping and fittings network. During hydraulic testing (shown as option A in FIG. 2), instead of the sprinkler assembly 206, the test plug 204 is attached to (or installed at) each sprinkler adapter 202 and pressurized firefighting fluid is introduced into the system. The fire suppression system is then checked for leaks, proper pressure, and proper flow rates to ensure that the design specification and safety standards are met. Upon successful completion of hydraulic testing, the test plug 204 is removed from the sprinkler adapter 202, the sprinkler assembly 206 is coupled to the sprinkler adapter 202 (shown as option B in FIG. 2), and the fire suppression system is commissioned. In other words, the sprinkler adapter 202 can be engageable with the test plug 204 during hydraulic testing period and with the sprinkler assembly 206 during non-hydraulic testing period of the fire suppression system (e.g., the fire suppression system 100).

Structural design of the test plug 204 simplifies installation and removal of the test plug 204 for hydraulic testing, while also preserving the integrity of the internal thread 218 of the sprinkler adapter 202 for engagement with the sprinkler assembly 206. The test plug 204 includes an elongate body 220 having one or more wings (e.g., wings 222A and 222B) protruding therefrom. Further, the elongate body 220 has a first portion 224 that is configured to engage with the sprinkler adapter 202, for example, with the internal thread 218. The one or more wings are operable to engage the test plug 204 with the sprinkler adapter 202.

Though FIG. 2 shows two wings 222A and 222B being provided on the elongate body 220, the scope of the disclosure is not limited to it. In some other embodiments, only one wing may be provided on the elongate body 220. In some other embodiments, more than two wings may be provided on the elongate body 220, without deviating from the scope of the disclosure.

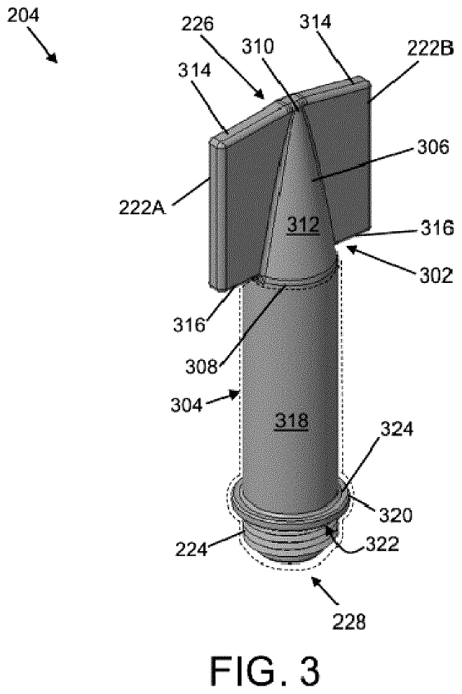

In some embodiments, the one or more wings may be provided at a distal end 226 of the elongate body 220 and the first portion 224 may be provided at a proximal end 228 of the elongate body 220 (as shown in FIG. 2). The distal end 226 and the proximal end 228 are defined with respect to the sprinkler adapter 202. However, in some other embodiments, the one or more wings can be provided at some other location, for example, at center of the elongate body 220 or any other location between the proximal end 228 and the distal end 226 of the elongate body 220, without deviating from the scope of the disclosure. Structural details of the test plug 204 are described more elaborately in conjunction with FIG. 3.

FIG. 3 is a diagram that illustrates the test plug 204 to be used during hydraulic testing of the fire suppression system (e.g., the fire suppression system 100 shown in FIG. 1), according to some embodiments of the present disclosure.

In some embodiments, the test plug 204 includes a winged head 302 and a post member 304. The winged head 302 includes the one or more wings (e.g., the wings 222A and 222B) that enable an operator or an individual to operate the test plug 204 for installation at or removal from the sprinkler adapter 202 (shown in FIG. 2). The one or more wings can have flat surfaces or indented surfaces to enable a secure grip during installation or removal of the test plug 204. Though in FIG. 3, the wings 222A and 222B are shown to be trapezoidal in shape, the scope of the disclosure is not limited to it. In some other embodiments, the wings 222A and 222B can have any other suitable shape, for example, butterfly wings, arcuated wings, rounded corner polygon wings, or the like, without deviating from the scope of the disclosure.

In some embodiments, the winged head 302 further comprises a central portion 306 having a base 308, a top 310, and a curved surface 312 extending between the base 308 and the top 310. In some embodiments, the central portion 306 may have a conical shape (as shown in FIG. 3) that tapers from the base 308 to the top 310. In some other embodiments, the central portion 306 can have any other shape such as a cylinder, a cuboid, a cube, a rounded edge polygon, a sphere, a flat 3D surface, or the like. In an example, the winged head 302 can be a butterfly head.

In some embodiments, the one or more wings (e.g., the wings 222A and 222B) may protrude outwards from the curved surface 312 of the central portion 306. For example, the two wings 222A and 222B may be provided on the curved surface 312 in opposing directions. In scenarios where two or more than two wings are provided in the winged head 302, the wings can have any suitable angle between them. One such example is shown in FIG. 3, where the wings 222A and 222B are angled at 180 degrees with respect to each other.

Each wing 222A and 222B may have a first edge 314 proximal to the top 310 of the central portion 306 and a second edge 316 proximal to the base 308 of the central portion 306. In a scenario where the central portion 306 is conical in shape, the first edge 314 may be longer than the second edge 316 to define the trapezoidal shape of the one or more wings. Further, the second edge 316 of the wings 222A and 222B may be orthogonal to the post member 304. In some other embodiments, the one or more wings may protrude from the top 310 of the central portion 306.

In some embodiments, the post member 304 is provided at the base 308 of the central portion 306. For example, the post member 304 may be an elongate structure that protrudes from the base 308 of the winged head 302. The post member 304 may include the first portion 224 and a second portion 318 such that the second portion 318 is provided between the winged head 302 and the first portion 224. In other words, the second portion 318 is proximal to the winged head 302 than the first portion 224. Further, the second portion 318 may be a non-threaded portion and the first portion 224 may be a threaded portion for engaging with the sprinkler adapter 202. In some embodiments, the first portion 224 may have undercut threads to prevent any damage to sprinkler adapter 202 during attachment and removal of the test plug 204.

In some embodiments, the second portion 318 may be longer than the first portion 224. In some other embodiments, the second portion 318 can be of the same length as the first portion 224 or shorter than the first portion 224, without deviating from the scope of the disclosure. In other words, the second portion 318 can have any suitable length as per requirement, without deviating from the scope of the disclosure.

In some embodiments (as shown in FIG. 3), both the first and second portions 224, 318 are cylindrical structures. In such a scenario, the first and second portions 224, 318 can have same or different diameters without deviating from the scope of the disclosure. In some other embodiments, the second portion 318 can have any other shape, for example, cuboid, rounded edge cuboid, or the like, without deviating from the scope of the disclosure.

In some embodiments, the first portion 224 may have external threads engageable with the internal thread 218 of the sprinkler adapter 202. However, in another embodiment where the sprinkler adapter 202 has external threads, the first portion 224 may have internal threads for engagement with the sprinkler adapter 202.

In some embodiments, the test plug 204 may further include a flanged portion 320 provided at a junction of the first portion 224 and the second portion 318. The flanged portion 320 may extend outwards in a radial direction from the post member 304. The flanged portion 320 may comprise a first surface 322 and an opposing second surface 324 such that the first surface 322 faces the first portion 224 and the second surface 324 faces the second portion 318. When the test plug 204 is engaged with the sprinkler adapter 202, the first surface 322 may engage with a surface (e.g., the outlet end 210B) of the sprinkler adapter 202.

The post member 304 and the central portion of 306 of the winged head 302 may form the elongate body 220 (shown in FIG. 2). In some embodiments, the test plug 204 is a one piece construction. Alternatively, the test plug 204 may be formed using multiple pieces joined together. In some embodiments, the test plug 204 can be hollow from inside. Alternatively, the test plug 204 may be formed as a solid one piece or multi-piece construction. In some embodiments, the test plug 204 may be formed of, for example, CPVC material, or any other suitable material.

FIG. 4 is a diagram that illustrates a test plug 400 to be used during hydraulic testing of the fire suppression system (e.g., the fire suppression system 100 shown in FIG. 1), according to some embodiments of the present disclosure. In FIGS. 3 and 4, common parts have been given like reference numerals, and a description thereof has been omitted unless there is a particular need. It is understood that description of common parts described in foregoing paragraphs applies to parts of FIG. 4 unless it is specifically described. In addition to one or more of the features described above, or as an alternative, the test plug 400 has wings 402A and 402B that have rounded corners 404.

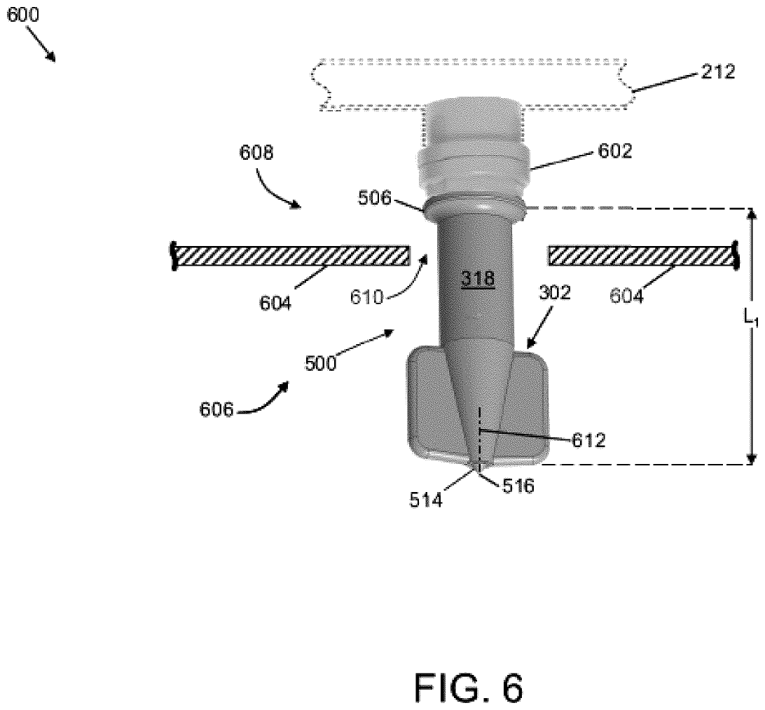

FIG. 5 is a diagram that illustrates a test plug 500 to be used during hydraulic testing of the fire suppression system (e.g., the fire suppression system 100 shown in FIG. 1), according to some embodiments of the present disclosure. In FIGS. 3 and 5, common parts have been given like reference numerals, and a description thereof has been omitted unless there is a particular need. It is understood that description of common parts described in foregoing paragraphs applies to parts of FIG. 5 unless it is specifically described.

In addition to one or more of the features described above, or as an alternative, the test plug 500 has wings 502A and 502B that have rounded corners 504.

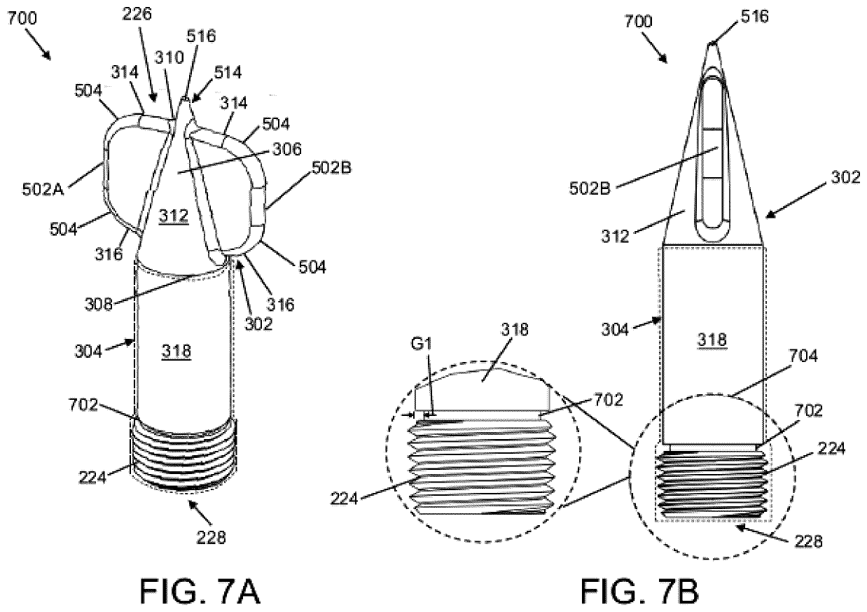

The test plug 500 may further include a flanged portion 506 provided at a junction of the first portion 224 and the second portion 318. The flanged portion 506 may extend outwards in a radial direction from the post member 304. The flanged portion 506 may comprise a first surface 508 and an opposing second surface 510 such that the first surface 508 faces the first portion 224 and the second surface 510 faces the second portion 318. When the test plug 500 is engaged with the sprinkler adapter 202, the first surface 508 may engage with a surface (e.g., the outlet end 210B) of the sprinkler adapter 202. Further, the test plug 500 may engage with a seal member (for example, a gasket or O-ring) of the sprinkler adapter 202 to provide a fluid tight seal during hydraulic testing. The flanged portion 506 may be similar to the flanged portion 320 of the test plug 204 except that smooth fillets are provided at a junction 512 of the second portion 318 and the flanged portion 506 and at a junction (not visible in FIG. 5) of the first portion 224 and the flanged portion 506. Further, the top 310 of the central portion 306 includes a conical section 514. The conical section 514 may extend outwards from the top 310 and terminate in a point, shown as a marking point 516. The use of the conical section 514 is described in conjunction with FIG. 6.

FIG. 6 is a diagram 600 that illustrates a fitting 602 engaged with the test plug 500, according to some embodiments of the present disclosure. In FIGS. 2, 3, and 6, common parts have been given like reference numerals, and a description thereof has been omitted unless there is a particular need. It is understood that description of common parts described in foregoing paragraphs applies to parts of FIG. 6 unless it is specifically described.

In assembled configuration shown in FIG. 6, the test plug 500 is coupled to the fitting 602 (e.g., the sprinkler adapter 202). Specifically, the first portion 224 (not visible in FIG. 6) of the test plug 500 is threaded into the fitting 602. The test plug 500 is then tightened, causing the flanged portion 506 to engage with the fitting 602.The test plug 500 may further engage with a seal member (e.g., a gasket, an O-ring, or any other suitable seal member) of the fitting 602 to form a fluid tight seal that prevents leaks between the test plug 500 and the fitting 602.

Further, in FIG. 6, an interior finish element 604 (e.g., a sheet of drywall, drop ceiling tiles, ceiling coverings, wall coverings, etc.,) is shown to have been installed in the space (e.g., a room). The interior finish element 604 divides the space into a first volume 606 (e.g., a below-ceiling volume, an occupied volume, a visible volume, etc.) below the interior finish element 604 and a second volume 608 (e.g., an above-ceiling volume, a storage volume, an obscured volume, etc.) above the interior finish element 604. The interior finish element 604 defines an aperture 610, through which the test plug 500 is installed. The first portion 224 and the second portion 318 of the test plug 500 extend upwards through the aperture 610 and into the second volume 608. Further, a length L₁ of the test plug 500 (e.g., a length remaining after subtracting a length of test plug portion that is fitted into the fitting 602 from a total length of the test plug 500) is defined such that the test plug 500 extends beyond the interior finish element 604. In an example, the length L₁ may be defined between the flanged portion 506 and the marking point 516. In some embodiments, the length L₁ may be greater than or equal to ⅝ inches. In some other embodiments, the length L₁ may be less than or equal to 4 inches. The interior finish element 604 may be coupled to a roof structure or a wall structure of the room or space using fasteners, adhesive, or another type of connection. The aperture 610 is cut into the interior finish element 604 prior to coupling the interior finish element 604 to the roof structure (e.g., using a hole saw, with a utility knife, etc.).

To determine where the aperture 610 should be placed, the interior finish element 604 can be aligned into a desired position (e.g., relative to other ceiling coverings, relative to walls, etc.), and pushed towards the test plug 500. As a result, the marking point 516 of the test plug 500 engages a surface of the interior finish element 604 facing the test plug 500, leaving a mark or depression indicating a position of a longitudinal axis 612 of the of the test plug 500. The aperture 610 can then be cut, centering the aperture 610 on the depression left by the marking point 516. This centers the aperture 610 on the longitudinal axis 612. The interior finish element 604 can then be coupled to the roof structure such that the test plug 500 extends through the aperture 610. In other words, the marking point 516 of the conical section 514 functions as an alignment feature for installation of various interior finish elements, for example, a drywall, drop ceiling tiles, drop ceiling coverings, wall tiles, wall coverings, etc.

Though FIG. 6 is described using the test plug 500, other test plugs 204, 400 can be similarly engaged with the fitting 602 without deviating from the scope of the disclosure.

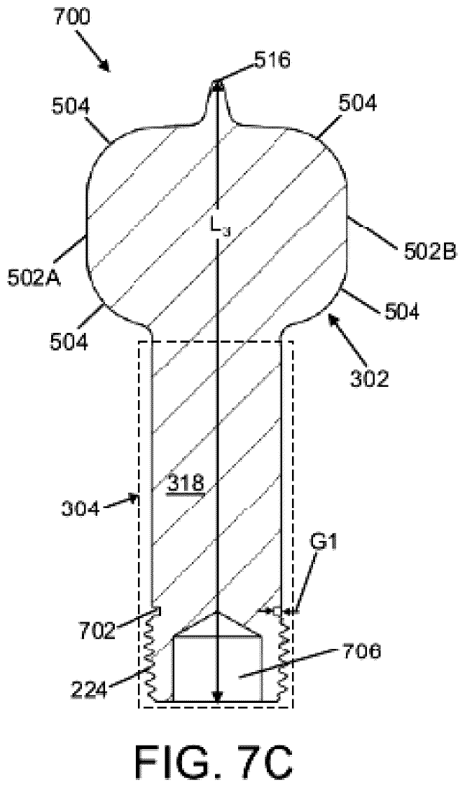

FIGS. 7A-7C are diagrams that illustrate a test plug 700 to be used during hydraulic testing of the fire suppression system (e.g., the fire suppression system 100 shown in FIG. 1), according to some embodiments of the present disclosure. More specifically, FIG. 7A illustrates an isometric view of the test plug 700, FIG. 7B illustrates a side view of the test plug 700, and FIG. 7C describes a cross-sectional view of the test plug 700.

In FIGS. 3, 5, and 7A-7C, common parts have been given like reference numerals, and a description thereof has been omitted unless there is a particular need. It is understood that description of common parts described in foregoing paragraphs applies to parts of FIG. 7A-7C unless it is specifically described.

Referring now to FIGS. 7A-7C, in addition to one or more of the features described above, or as an alternative, the test plug 700 may not include any flanged portion (e.g., the flanged portion 320, 506) between the first portion 224 and the second portion 318. Instead, the first portion 224 and the second portion 318 may be spaced apart from each other by way of a spacer 702. The spacer 702 can be of cylindrical shape or any other suitable shape without deviating from the scope of the disclosure. Further, the spacer 702 may not extend beyond outer surfaces of the first portion 224 and the second portion 318. For example, as shown in a cut section view 704 of the test plug 700, a gap G₁ exists between outer surfaces of the spacer 702 and the second portion 318.

However, in other embodiments, the first portion 224 and the second portion 318 may not be spaced apart from each other. In such embodiments, the first portion 224 may be provided adjacent to the second portion. For example, the first portion 224 may be in contact with the second portion 318 and no flanged portion or spacer is provided therebetween.

In some embodiments, the first portion 224 may be a solid threaded portion. However, in some other embodiments, for example, as shown in FIG. 7C, the first portion 224 may be a threaded section incorporating a hollow or bored space 706 therein. Such hollow or bored space 706 may be incorporated in the first portion 224 to reduce the weight or material volume of the test plug 700. The hollow or bored space 706 can be either visible on the first portion 224 or concealed within the first portion 224.

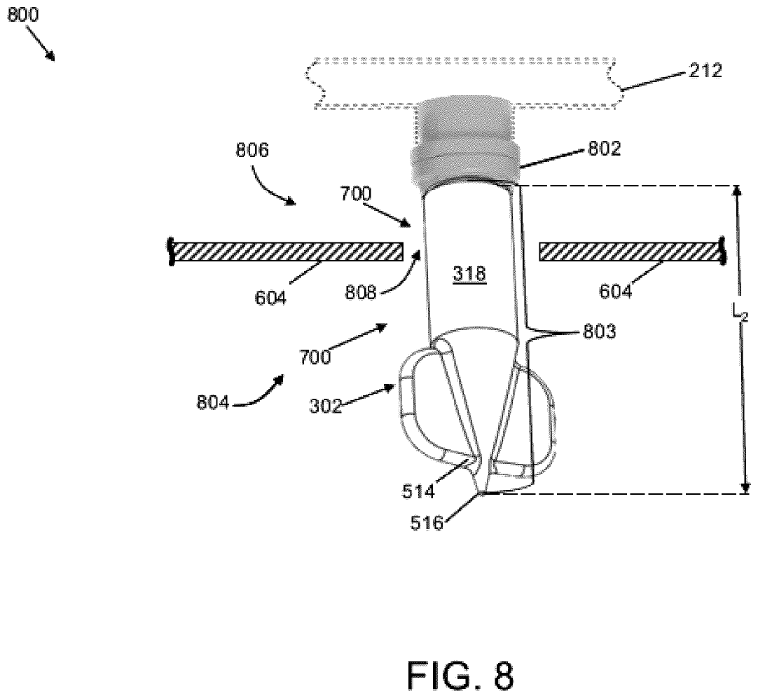

FIG. 8 is a diagram 800 that illustrates a fitting 802 engaged with the test plug 700, according to some embodiments of the present disclosure. In FIGS. 2, 3, 5, 6, and 7A-7C common parts have been given like reference numerals, and a description thereof has been omitted unless there is a particular need. It is understood that description of common parts described in foregoing paragraphs applies to parts of FIG. 8 unless it is specifically described. Though FIG. 8 is described using the test plug 700, other test plugs 204, 400, 500 can be similarly engaged with the fitting 802 without deviating from the scope of the disclosure.

In assembled configuration shown in FIG. 8, the test plug 700 is coupled to the fitting 802 (e.g., the sprinkler adapter 202). Specifically, the first portion 224 (not visible in FIG. 8) of the test plug 700 is threaded into the fitting 802. A portion of the test plug 700 that remains outside the fitting 802, after the first portion 224 is successfully threaded into the fitting 802, is hereinafter referred to and designated as an exposed portion 803.

The test plug 700 may further engage with a seal member (e.g., a gasket, an O-ring, or any other suitable seal member) of the fitting 802 to form a fluid tight seal that prevents leaks between the test plug 700 and the fitting 802.

Further, in FIG. 8, the interior finish element 604 is shown to have been installed in the space (e.g., a room). The interior finish element 604 divides the space into a first volume 804 (e.g., a below-ceiling volume, an occupied volume, a visible volume, etc.) below the interior finish element 604 and a second volume 806 (e.g., an above-ceiling volume, a storage volume, an obscured volume, etc.) above the interior finish element 604. The interior finish element 604 defines an aperture 808, through which the test plug 700 is installed. The first portion 224 and the second portion 318 of the test plug 700 extend upwards through the aperture 808 and into the second volume 806.

Further, a length L₂ of the exposed portion 803 is defined such that the test plug 700 extends beyond the interior finish element 604. The length L₂ may be obtained after subtracting a length of test plug portion that is fitted into the fitting 802 from a total length (e.g., a length L₃ shown in FIG. 7C) of the test plug 700. In some embodiments, the length L₂ may be greater than or equal to ⅝ inches. In some other embodiments, the length L₂ may be less than or equal to 4 inches. The interior finish element 604 may be coupled to a roof structure or a wall structure of the room or space using fasteners, adhesive, or another type of connection. The aperture 808 is cut into the interior finish element 604 prior to coupling the interior finish element 604 to the roof structure (e.g., using a hole saw, with a utility knife, etc.), for example, as described in the foregoing description of FIG. 6.

Though in FIGS. 2-8, the use of the test plug 204, 400, 500, 700 is described with respect to the sprinkler adapter 202, the scope of the disclosure is not limited to it. In other embodiments, the test plug 204, 400, 500, 700 can be used at any fitting outlet (e.g., fluid supply piping outlet) provided for sprinkler attachment to plug the fitting outlet during hydraulic testing.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

I/We claim:

1. A test plug for use with a sprinkler adapter or a fluid supply piping outlet, comprising:
a winged head to operate the test plug; and
a post member protruding from the winged head and configured to engage with the sprinkler adapter or the fluid supply piping outlet.

2. The test plug of claim 1, wherein the winged head comprises a central portion having a base, a top, and a curved surface extending between the base and the top.

3. The test plug of claim 2, wherein the central portion has conical shape that tapers from the base to the top.

4. The test plug of claim 2, wherein the post member is provided at the base of the central portion.

5. The test plug of claim 2, wherein the winged head further comprises one or more wings.

6. The test plug of claim 5, wherein the one or more wings are flat surfaces that enable a secure grip during installation or removal of the test plug.

7. The test plug of claim 5, wherein the one or more wings are orthogonal to the post member.

8. The test plug of claim 5, wherein each wing has a first edge proximal to the top of the central portion and a second edge proximal to the base of the central portion, and wherein the first edge is longer than the second edge.

9. The test plug of claim 2, further comprising a conical section provided at the top of the winged head, the conical section terminating in a marking point.

10. The test plug of claim 9, wherein the marking point of the conical section functions as an alignment feature for installation of one or more interior finish elements.

11. The test plug of claim 2, wherein the post member comprises a first portion engageable with the sprinkler adapter or the fluid supply piping outlet and a second portion such that the second portion is provided between the winged head and the first portion.

12. The test plug of claim 11, further comprising a spacer provided between the first portion and the second portion.

13. The test plug of claim 11, wherein the first portion is provided adjacent to the second portion.

14. The test plug of claim 11, wherein the first portion has undercut threads formed thereon for engagement with the sprinkler adapter or the fluid supply piping outlet.

15. The test plug of claim 14, wherein a length of a portion of the test plug that remains outside the sprinkler adapter or the fluid supply piping outlet after the first portion is engaged with the sprinkler adapter or the fluid supply piping outlet is greater than or equal to ⅝ inches.

16. The test plug of claim 14, wherein a length of a portion of the test plug that remains outside the sprinkler adapter or the fluid supply piping outlet after the first portion is engaged with the sprinkler adapter or the fluid supply piping is less than or equal to 4 inches.

17. The test plug of claim 11, wherein the first portion incorporates a hollow space therein.

18. A test plug for a sprinkler adapter or a fluid supply piping outlet, comprising:
an elongate body having one or more wings protruding therefrom and a portion configured to engage with the sprinkler adapter or the fluid supply piping outlet, wherein the one or more wings are operable to engage the test plug with the sprinkler adapter or the fluid supply piping outlet.

19. A fire suppression system, comprising:
a sprinkler adapter;
a sprinkler assembly; and
a test plug, wherein the sprinkler adapter is engageable with the sprinkler assembly during non-hydraulic testing period of the fire suppression system and with the test plug during hydraulic testing period of the fire suppression system, the test plug comprising:
a winged head operable to engage the test plug with the sprinkler adapter; and
a post member protruding from the winged head and configured to engage with the sprinkler adapter.
